(19) United States
(12) Patent Application Publication
(10) Pub. No.: US 2014/0324734 A1
(43) Pub. Date: Oct. 30, 2014

(54) Computerized Method And System For Financing By EB-5 Investor Visa Regional Center

(71) Applicant: Michael Lee Mattox, Lacey, WA (US)

(72) Inventor: Michael Lee Mattox, Lacey, WA (US)

(21) Appl. No.: 14/330,201

(22) Filed: Jul. 14, 2014

Related U.S. Application Data
(63) Continuation-in-part of application No. 13/760,133, filed on Feb. 6, 2013.
Application No. 13/760,133 is a continuation-in-part of application No. 13/448,334, filed on Apr. 16, 2012.

(51) Int. Cl. G06Q 40/06; G06Q 50/26

(52) U.S. Cl. CPC G06Q 40/06; G06Q 50/26
USPC 705/36 R

(57) ABSTRACT

A computer-implemented financed commercial economic system and method for EB-5 immigrant investor visa programs through a regional center directed to promotion of economic growth, improved economic regional productivity, job creation and increased capital investment, in which EB-5 investors by a capital investment for economic commercialization of projects and an electronic database accessible through a communications network to maintain regional center and EB-5 investor information, with an escrow account of funds from sales of products produced by the projects, and returning of capital investments to the EB-5 investors after a pre-determined period of time with the proceeds of the escrow account, with an agreement providing management compensation from asset rights of the EB-5 investors.

### FIELD OF THE INVENTION

The invention relates generally to computer software. More specifically, the invention relates to methods and systems for financing investments that meet the requirements of the United States government's EB-5 immigrant investor visa program, while providing compensation for management of a funded economic development project by assignment of asset rights by EB-5 investors.

### BACKGROUND OF THE INVENTION

The United States Customs and Immigration Service (“USCIS”) administers the Immigrant Investor Program, also known as “EB-5,” created by Congress in 1990 to stimulate the U.S. economy through job creation and capital investment by foreign investors. Certain EB-5 visas are set aside for investors in regional centers designated by USCIS based on proposals for promoting economic growth. Regional centers may be any economic entity, public or private, which is involved with the promotion of economic growth, improved regional productivity, job creation, and increased domestic capital investment. Investments made through regional centers can take advantage of a more expansive concept of job creation, including both “indirect” and “direct” jobs.

The organizers of a regional center seeking the “Regional Center” (“RC”) designation from USCIS must submit a proposal, supported by economically or statistically valid forecasting tools, showing how the regional center plans to focus on a geographical region within the United States. The proposal must explain how the regional center will promote economic growth in that region, in verifiable detail (using economic models in some instances), jobs will be created directly or indirectly through capital investments made in accordance with the regional center's business plan. In addition, the proposed regional center must demonstrate the amount and source of capital committed to the regional center; the promotional efforts made and planned for the business project; and how the regional center will have a positive impact on the regional or national economy.

All EB-5 investors must invest in a commercial enterprise that will create or preserve at least 10 full-time jobs for qualifying U.S. workers within two years (or under certain circumstances, within a reasonable time after the two-year period) of the immigrant investor's admission to the United States as a Conditional Permanent Resident. Jobs created may be either direct or indirect jobs: Direct jobs are actual identifiable jobs for qualified employees located within the commercial enterprise into which the EB-5 investor has directly invested his or her capital, and indirect jobs are those jobs shown to have been created collaterally or as a result of capital invested in a commercial enterprise affiliated with a regional center by an EB-5 investor.

The minimum qualifying investment in the United States is $1 million, although the minimum qualifying investment either within a high-unemployment area or rural area in the United States is $500,000.

To that end, the EB-5 program rigidly classifies moneys used in job creation investment activities in accounting for qualified investments. Certain routine business expenses are excluded from being included as a qualified investment expense leading to job creation. Such after-the-fact evaluation by the EB-5 program administrators my determine that improper expenses were included, and disallow these expenses in a determination whether the minimum required investment was applied towards job creation. The EB-5 investor thus risks denial of the right to receive the visa. In one aspect, the, minimizing the additional EB-5 investor funds necessary for implementation of the economic development projects may be important.

The economic models used to demonstrate the projected job creation impact and to prove actual job creation may be of any form, as long as they are recognized as legitimate models. As a result, for some time it has been known that computerized economic models such as RIMMS II and IMPLAN may serve this purpose. However, no one has addressed the complexities added by attempting to model and finance massive construction projects within the requirements of the EB-5 program, including the difficulty of identifying and describing the thousands of job positions created under dozens of contractors working on the projects, not to mention physically identifying associated federal tax documents relating to the same. Moreover, the complex task of handling the scores of instructions, transactions, storage functions, deliveries of funds and bonds, and record keeping entailed by the actual financing associated with such massive projects has not been addressed. All of these potential problems highlight the need for a method for platinum government bond financing by an EB-5 regional center that addresses the complexities of massive projects with extremely high levels of financing required, staggered issuing of bonds, multiple spending cycles, multiple sectors, and thousands of created jobs.

Accordingly, there is a need in the art for a method and system for increased promotion of economic growth, improved economic regional productivity, job creation and increased capital investment while providing compensation for management of EB-5 projects developed with EB-5 investor funds. It is to such that the present invention is directed

### SUMMARY OF INVENTION

The present invention provides, among other things, a computerized method and system for automating and facilitating the performing and processing of tasks, information transfer, and storage associated with the financing investments that meet the requirements of the United States government's EB-5 immigrant investor visa program and an agreement for management compensation from asset rights of EB-5 investors. More particularly, the present invention provides a computer-implemented commercial financial economic and investment development system establishing and operating economic development projects with investments that meet the requirements of the United States government EB-5 immigrant investor visa program, comprising a microprocessor center configured for the promotion of economic growth, improved economic productivity in a region, job creation and increased capital investment through at least one economic development project financed by a project capital investment within U.S. Customs and Immigration Services guidelines for EB-5 immigrant investor visa program. A plurality of EB-5 capital investments each purchasing a portion of the project capital investment issued by an entity established for economic commercialization of the economic development project funded by the project capital investment, the project capital investment comprising a bond investment having a plurality of bonds, each EB-5 capital investment received from a respective one of a plurality of EB-5 investors that participate in the economic development project. A computer database operatively connected to the microprocessor center accessible through a communications network connecting at least one workstation to receive, maintain, and display economic development project and EB-5 investor information, including financing criteria information comprising one or more of infrastructure research information, economic modeling information, business and project document information, marketing information, and funds and investment transaction information. A compensation agreement provides for assignment of asset rights of each of the EB-5 investors to a general manager managing the economic development project. An escrow account for holding EB-5 capital investments of the EB-5 investors until sale of the bonds from the project capital investment. A securities depository having a plurality of broker accounts through which a broker/dealer associated with a respective one of the broker accounts pays for the bonds using the escrow account and receives the paid-for bonds, the securities depository organized as a banking organization, a clearing corporation, and a securities clearing agency and a plurality of accounts provided by the broker/dealer, each account to hold a pro-rata value representative of the sold bonds in association with a respective one of the plurality of EB-5 investors based on the EB-5 capital investment thereto. Each one of the plurality of EB-5 investors, being invested in the economic development project funded by the project capital investment, receive an EB-5 immigrant visa.

Advantages of the present invention include providing a smoother, simpler, continuous process from the beginning to the end of the entire financing process; reducing work by all parties, allowing the process to be more highly automated, eliminating and reducing work currently being performed manually; reducing redundant and repetitive tasks of manually entering the same information numerous times in different computer programs, so information can be entered once for the entire transaction, not just portions of the transaction; allowing transaction information to be instantly available to immediately perform additional tasks anywhere in the process; reducing the cost of completing a transaction; reducing the number of personnel necessary to complete a transaction; and providing for greater reliability to be built into the process, while minimizing additional EB-5 investor funds necessary for operation of the economic development projects.

Other aspects and advantages of the invention will be apparent from reading the following description and the appended claims in conjunction with the drawings.

### BRIEF DESCRIPTION OF DRAWINGS

FIG. 1 shows a flow chart diagram of the method of the present invention.

FIG. 2 illustrates a System Overview and Architecture Showing Ancillary Databases and Systems Detail for platinum bond financing by EB-5 investor visa regional center.

FIG. 3 illustrates a System Overview and Architecture of a computerized method for platinum bond financing by EB-5 investor visa regional center.

FIG. 4 illustrates a view depicting Basic Financing and Workflow Process.

FIGS. 5A and 5B illustrate in schematic view an EB-5 investor program using a regional center system.

FIGS. 6A and 6B illustrate a flow chart of the EB-5 process using a regional center in accordance with the present invention.

FIGS. 7A and 7B illustrate in schematic view an alternate embodiment of a computerized method for platinum bond financing by EB-5 investor program using a regional center system.

### DETAILED DESCRIPTION

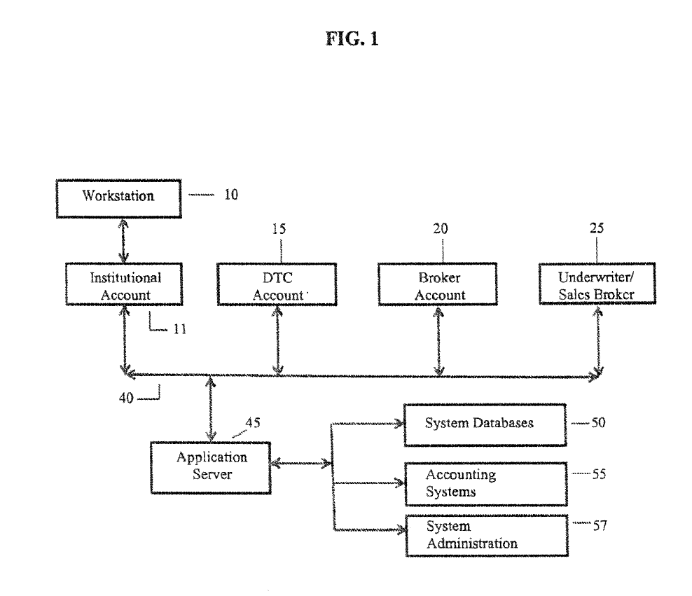

The present invention relates to a method for platinum government bond financing by an EB-5 regional center that addresses the complexities of massive projects with extremely high levels of financing required, staggered issuing of bonds, multiple spending cycles, multiple sectors, and thousands of jobs created over a distributed computing network (See FIG. 1).

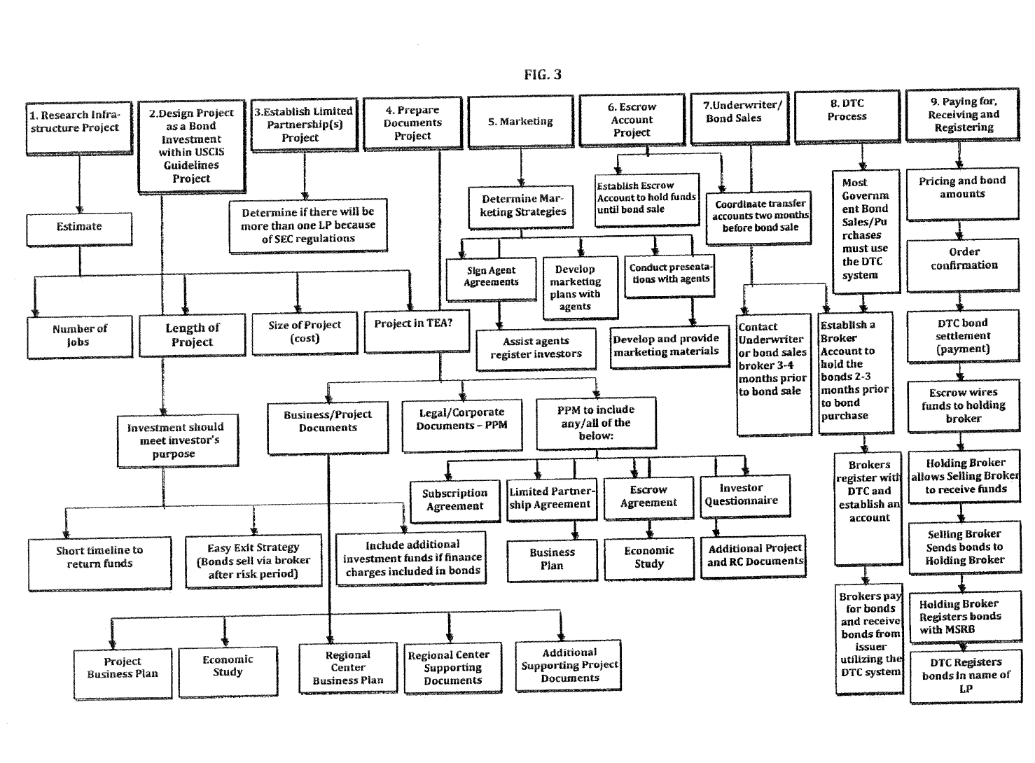

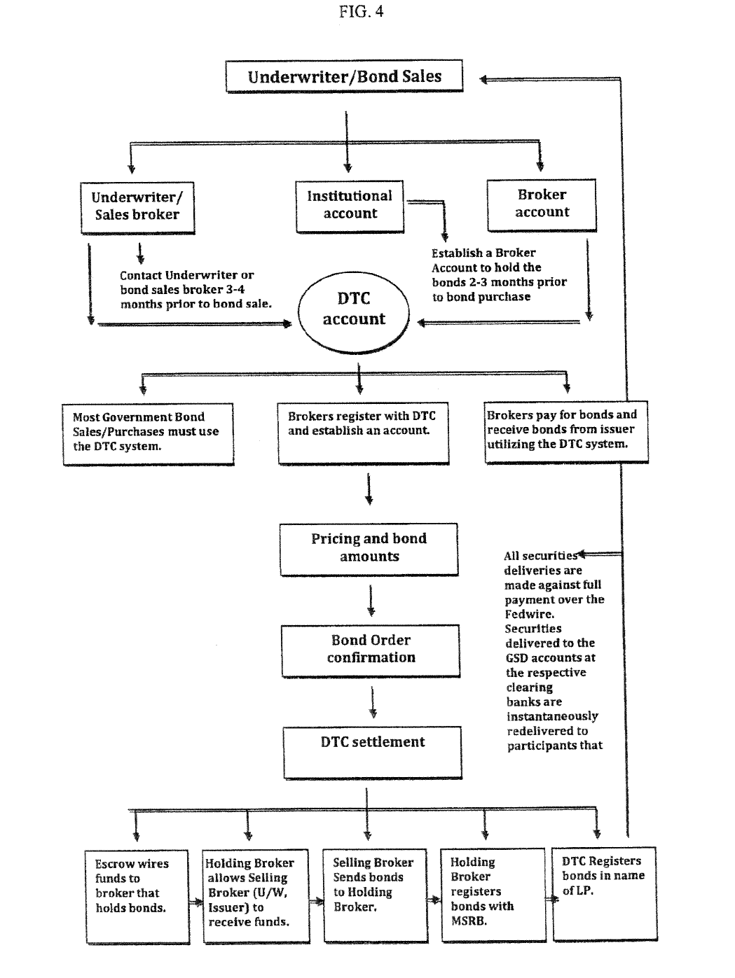

FIG. 3 shows a diagram of the method for platinum government bond financing 40. To better understand how the method 40 works, it is first necessary to understand typical electronic document structures. A compound file, such as an OLE/COM document, is actually an object-oriented collection of data streams. These streams are grouped together into storages. These storages can contain other storages in a hierarchical manner. The lowest level storage is called the root storage. The root storage contains all the information in the document and it is what we generally call the file.

When a document is embedded in another document, the embedded document's root storage becomes substorage in the parent document. The streams can be complex structures themselves, and are usually composed of multiple objects, which are themselves streams. For example, the Office Art layer introduced in Microsoft's Office 97® embeds drawing objects directly into the primary data stream of a Word document. The shape and inlineshape objects in Office Art are capable of storing images in file formats such as bitmaps, JPEGs, GIFs and PNGs, and other types of binary data. The shape and inlineshape objects are also the key to understanding compression techniques used in Office 2000® and Windows XP® versions. To parse the data in a compound file correctly, the file must be broken down into its elementary data streams. The elementary streams can be filtered and reassembled into a new document that is free of hidden data. It is important to note that compound files, such as OLE/COM, and other complex non-compound file types, like HTML and XML, are all handled in similar fashion by the DDE 64. FIG. 1 shows a flow chart of protocol in accordance with one embodiment of the present invention. In this embodiment, the method of utilizing government bonds for EB-5 Visa investment offerings begins with researching an appropriate infrastructure project. An estimate must be made regarding the proposed number of jobs; the length of the project; the cost of the project; and confirmation of whether the project is in a targeted employment area.

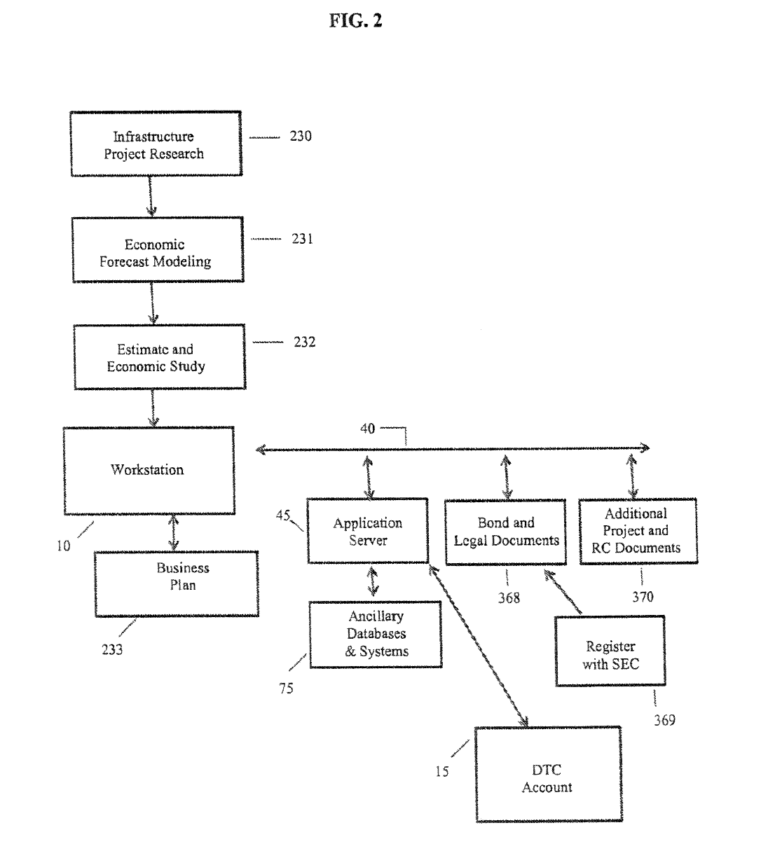

While the system may be implemented on one computer system such as a single personal computer, it is more likely to be implemented on a distributed computing network 40 (See FIGS. 1, 2). The distributed computing network 40 may be a local area network (LAN) or a wide area network (WAN), such as, for example, the Internet, a hard-wired or wireless network, or any combination thereof, and most likely will be implemented on the Internet or an Extranet.

One or more application servers 45 run computer program processes which perform the functions necessary to send and display screens to users to enter and view information, and perform their activities on remote, or local computing devices, receive information back from users, process it if necessary, store it in one or more databases 50, send it if necessary for use or processing by one or more ancillary systems or databases 75 (See FIG. 2) to perform necessary ancillary processes or activities, receive back results and save to one or more databases 75 (See FIG. 2), and make it available to all appropriate parties by again sending and displaying screens to users to view and perform subsequent activities on computing devices.

Although there are numerous computer technologies with which this computer process could be developed and carried out, the preferred embodiments of the invention provide a comprehensive client-and-server technology (See FIG. 2) allowing the users to use a personal computer (PC) workstation 10 with a display to view graphical user interfaces (GUI) screens, and common input devices, for example a mouse and keyboard, which access an application server(s) 45 over the Internet or over a secure “Extranet,” via TCP/IP. The application server(s) 45 would connect to one or more relational databases 50 (See FIG. 1) for transaction data to be saved and retrieved. These databases could be built in typical database programs such as, for example, SQL, DB2, and Oracle, and the application server process could be programmed in such tools as, for example, ASP and DOTNET programming environment from Microsoft, PeopleSoft's “Portal,” or IBM's “Domino,” “Websphere” and “Webspere Portal” in conjunction with using XML, JAVA, and HTML, or other programming tools. In addition, there may be one or more “ancillary” databases and systems 75 (See FIG. 2) with which the application server can exchange information. These “ancillary databases 75 may be developed with the system, or they may be provided by third parties, and accessed via programming tools such as, for example, XML.

The preferred embodiments and best mode of carrying out the invention are client-server architecture with one or more application servers 45 which run and manage the process. Actions taken by users on their client computer workstations 10 are processed by the application server 45 which processes information, performs tasks, serves up client user screens on computing devices, sends and retrieves information to and from databases or ancillary computer processes, and distributes information according to one or more application server programs to the workstation, managing and making the entire process possible.

The terms used hereinafter, such as for example “application,” “application server,” “computer program,” “computer process,” “computer application,” etc., are used interchangeably and deemed for the purposes of this application and claims to mean one or more computer applications performing the computer functions herein described unless otherwise indicated.

As described herein, in various embodiments, one or more server(s), client computer(s), application computer(s) and/or other computers can be utilized to implement one or more aspects of the invention. Illustrative computers can include, e.g. a central processing unit; memory (e.g. RAM, etc.) data storage (e.g., hard drives, etc.) input/output ports (e.g., parallel and/or serial ports, etc.); data entry devices (e.g. key boards, etc.); etc. In addition, client computers may contain, in come embodiments, browser software for interacting with the server(s), such as, for example, using hypertext transfer protocol (HTTP) to make requests of the server(s) via the Internet or the like.

The system may use one or more relational databases 50 (See FIG. 1) with a variety of structures which may include data categories such as, for example: regional center information, buyer information, sale information, etc.

While users may use any form of electrical computing device or general purpose computing machines or devices for accessing and interacting with the system 40, which could include personal computers, network terminals, digital Internet cell phones, palm pilots or telephone voice response or touch-tone technology, the description herein describes the use of a common personal computer with a display, a keyboard, and a pointing device such as a mouse. Electronic computing devices may also include any other suitable programmable electronic devices consistent with the invention.

It is pointed out that the order of steps or activities, and whether particular tasks are performed manually or automatically, is flexible and can be programmed to be varied to give the process and users as much flexibility as possible. In addition, various steps may be modified, simplified, and one or more tasks may be combined to simplify and streamline the overall process.

It is also pointed out that certain of the drawings herein reflect the “workflow” of the system, rather than the actual system architecture. In particular, FIG. 3 shows the process from start to finish, rather than the fact that all information, whether the result of user input or processes performed, in most cases is transferred to and from the application server(s) 45 and databases 50.

The first stage of the analysis brings in the element of human judgment and analysis: designing a project as a Bond Investment within USCIS Guidelines. From workstation 10, infrastructure project research 230 is directed toward finding an investment that meets the investor's purpose, provides a short timeline to return funds, has an easy exit strategy, such as having the bonds sell via broker after the risk period, and includes additional investment funds if finance charges will be included in the bonds. Economic forecast modeling 231 is employed to develop an economic study 232 and estimate 232 of costs and benefits of the proposed project. Further, the project offerer may negotiate with a bonding authority of a municipality (city, county, state, or other bonding authority) for the right to purchase a series or allotment of bonds for economic development or job creation. The bonds would have a negotiated price available for purchase for EB-5 investors.

Next is the establishment of a limited partnership(s) (“LP”) to own and manage the process. It must be determined if there will be more than one LP because of SEC regulations, and then documents 368 must be prepared. The business/project documents to be prepared include the Project Business Plan 233; the Economic Study 232; the Regional Center Business Plan 233; the Regional Center Supporting Documents 370; and any necessary additional supporting project documents 370.

In addition, legal/corporate documents 368 must be prepared, including a private placement memorandum (PPM) that may include a Subscription Agreement; Limited Partnership Agreement; Escrow Agreement; Investor Questionnaire; and any necessary additional project and RC documents. Marketing strategies must be determined; steps include signing agent agreements 370; determining marketing plans 370 with agents; conducting presentations 370 with agents; assisting agents with the registration of investors 370; and developing and providing marketing materials 370. In addition, an escrow account must be established to hold funds until the bond sale. Steps include coordinating transfer accounts two months before the bond sale; contacting an underwriter or bond sales broker 25 three to four months prior to the bond sale; establishing an institutional account 11 to purchase bonds; and establishing a broker account 20 to hold the bonds two to three months prior to bond purchase. The broker 25 must have a Depository Trust Company (“DTC”) account 15 (See FIG. 1), because most government bond sales/purchases must use the DTC system. The brokers 25 register with DTC and establish an account, paying for bonds and receiving bonds from an issuer utilizing the DTC system.

The Depository Trust Company (“DTC”), New York, N.Y., acts as securities depository for the bonds. In the illustrative embodiment, the bonds are Series 2012C Bonds but may be any municipal bond. Generally, the bonds will be issued as fully-registered securities registered in the name of DTC's partnership nominee. In the illustrated embodiment, the Series 2012C Bonds will be issued as fully-registered securities registered in the name of Cede & Co. (DTC's partnership nominee) or such other name as may be requested by an authorized representative of DTC. One fully-registered Bond certificate will be issued for each maturity within a series of the Bonds in the principal amount of such maturity and will be deposited with DTC.

DTC, currently the world's largest depository, is a limited-purpose trust company organized under the New York Banking Law, a “banking organization” within the meaning of the New York Banking Law, a member of the Federal Reserve System, a “clearing corporation” within the meaning of the New York Uniform Commercial Code, and a “clearing agency” registered pursuant to the provisions of Section 17A of the Securities Exchange Act of 1934. DTC holds and provides asset servicing for over 3.5 million issues of U.S. and non-U.S. equity issues, corporate and municipal debt issues, and money market instruments (from over 100 countries) that DTC's participants (“Direct Participants”) deposit with DTC.

DTC also facilitates the post-trade settlement among Direct Participants of sales and other securities transactions in deposited securities, through electronic computerized book-entry transfers and pledges between Direct Participants' accounts. This eliminates the need for physical movement of securities certificates. Direct Participants include both U.S. and non-U.S. securities brokers and dealers, banks, trust companies, clearing corporations, and certain other organizations. DTC is a wholly-owned subsidiary of The Depository Trust & Clearing Corporation (“DTCC”). DTCC is the holding company for DTC, National Securities Clearing Corporation and Fixed Income Clearing Corporation, all of which are registered clearing agencies. DTCC is owned by the users of its regulated subsidiaries. Access to the DTC system is also available to others, such as both U.S. and non-U.S. securities brokers and dealers, banks, trust companies, and clearing corporations that clear through or maintain a custodial relationship with a Direct Participant, either directly or indirectly (“Indirect Participants”).

Purchases of Bonds under the DTC system must be made by or through Direct Participants, which will receive a credit for the Bonds on DTC's records. The ownership interest of each actual purchaser of each Bond (“Beneficial Owner”) is in turn to be recorded on the Direct and Indirect Participants' records. Beneficial Owners will not receive written confirmation from DTC of their purchase. Beneficial Owners are, however, expected to receive written confirmations providing details of the transaction, as well as periodic statements of their holdings, from the Direct or Indirect Participant through which the Beneficial Owner entered into the transaction. Transfers of ownership interests in the Bonds are to be accomplished by inputting into a terminal entries made on the books of Direct and Indirect Participants acting on behalf of Beneficial Owners. Beneficial Owners will not receive certificates representing their ownership interests in the Bonds, except in the event that use of the book entry system for the Bonds is discontinued.

To facilitate subsequent transfers, all Bonds deposited by Direct Participants with DTC are registered in the name of DTC's partnership nominee, Cede & Co., or name of such other nominee as may be requested by an authorized representative of DTC. The deposit of Bonds with DTC and their registration in the name of Cede & Co. or such other DTC nominee do not affect any change in beneficial ownership. DTC has no knowledge of the actual Beneficial Owners of the Bonds; DTC's records reflect only the identity of the Direct Participants to whose accounts such Bonds are credited, which may or may not be the Beneficial Owners. The Direct and Indirect Participants will remain responsible for keeping account of their holdings on behalf of their customers.

When notices are given, they are sent by the Bond Registrar to DTC only. Conveyance of notices and other communications by DTC to Direct Participants, by Direct Participants to Indirect Participants, and by Direct Participants and Indirect Participants to Beneficial Owners are governed by arrangements among them, subject to any statutory or regulatory requirements as may be in effect from time to time. Redemption notices are sent to DTC. If less than all of the Bonds within a Series are being redeemed, DTC's practice is to determine by lot the amount of the interest of each Direct Participant in such issue to be redeemed.

Neither DTC nor the DTC nominee consents or votes with respect to the Bonds unless authorized by a Direct Participant in accordance with DTC's MMI Procedures. DTC mails an Omnibus Proxy to the state as soon as possible after the record date. The Omnibus Proxy assigns the DTC nominee's consenting or voting rights to those Direct Participants to whose accounts the Bonds are credited on the record date (identified in a listing attached to the Omnibus Proxy).

Payments on the Bonds will be made to the DTC nominee, or such other nominee as may be requested by an authorized representative of DTC. DTC's practice is to credit Direct Participants' accounts upon DTC's receipt of funds and corresponding detail information from the state or the Bond Registrar, on payable date in accordance with their respective holdings shown on DTC's records. Payments by Participants to Beneficial Owners will be governed by standing instructions and customary practices, as is the case with securities held for the accounts of customers in bearer form or registered in “street name,” and will be the responsibility of such Participant and not of DTC, the Bond Registrar or the state, subject to any statutory or regulatory requirements as may be in effect from time to time. Payments to the DTC nominee are the responsibility of the state or the Bond Registrar, disbursement of such payments to Direct Participants will be the responsibility of DTC, and disbursement of such payments to the Beneficial Owners will be the responsibility of Direct and Indirect Participants.

DTC may discontinue providing its services as depository with respect to the Bonds at any time by giving reasonable notice to the state or the Bond Registrar. Under such circumstances, in the event that a successor depository is not obtained, Bond certificates are required to be printed and delivered. The state may decide to discontinue use of the system of book-entry-only transfers through DTC (or a successor securities depository). In that event, Bond certificates will be printed and delivered to DTC.

Finally, the steps of paying for, receiving, and registering bonds call for the selling broker to discuss pricing and bond amounts for the bond order, which is usually confirmed within one day. The amount of the bond settlement (payment) is determined in order to prepare for payment; next, the escrow wires the necessary funds to the broker that holds the bonds. The holding broker allows the selling broker, underwriter, and/or issuer to receive the funds; the selling broker then sends the bonds to the holding broker, who registers the bonds with the Municipal Securities Registration Board (MSRB). Ultimately, DTC registers the bonds in the name of the LP.

Alternative bond purchase processes are within the scope of the present invention. Bond purchases may be processed using Received Versus Purchase (RVP) accounts as well as Delivery Versus Purchase (DVP) accounts. RVP accounts may be established at the receiving brokerage firm. The RVP accounts allow orders to be placed through the underwriter directly. The underwriter would have a DVP account. The custodian brokerage firm RVP account would need to meet appropriate “know your client” rules for opening the accounts. The DVP account may not need to follow those rules as stringently. However, the underwriter would need to be willing to purchase the bonds and to pull or receive the funds at a later time. There may be a credit approval requirement or standard for opening and maintaining this type of account. Conventionally, underwriting firms approve accounts in the $10 to $20 million dollar range and an exception approval may be necessary in order to have an account for a substantially increased amount. These types of accounts are typically set up for mutual fund companies or other financial institutions. The DTC system is still used for reporting the bonds purchased or sale through MSRB.

Bond laddering with mutual fund companies may also be accomplished. Brokerage firms with advisory platforms manage assets directly. In this environment, an advisory account may be opened at the brokerage firm and contract with mutual fund providers to buy bonds at new issue directly. The bonds may be purchased directly from the state through the underwriter, delivered to the custodial advisory account and managed on an ongoing basis by the mutual fund manager. This account may need to satisfy “know your client” and meet anti-money-laundering rules. In addition there would need to be a contract and information provided to the mutual fund company. However, the mutual fund company may rely on the due diligence of the brokerage firm and may not generally need to practice their own account screening processes.

It is to be appreciated that large mutual fund companies buy municipal bonds on an on-going basis. Underwriters are incentivized in that underwriters obtain sales commissions for bonds sold to mutual fund companies which are customers rather than sell to customers of other brokerage firms. Differences in sales prices may reflect that the brokerage firms with additional selling avenues, may offer better sales price. The DTC system discussed above would be used for reporting the bonds purchase or sale through MSRB.

Custodial account is a common way to purchase bonds at new issue. The purchase order would be entered through the custodial brokerage account to the underwriter. The underwriter allocates bonds to the mutual fund companies and other brokerage firms at discretion. The funds are sent from the custodial brokerage accounts and the bonds settle in that account. The order would then be recorded by the custodial brokerage firm through the DTC system and reported to the MSRB.

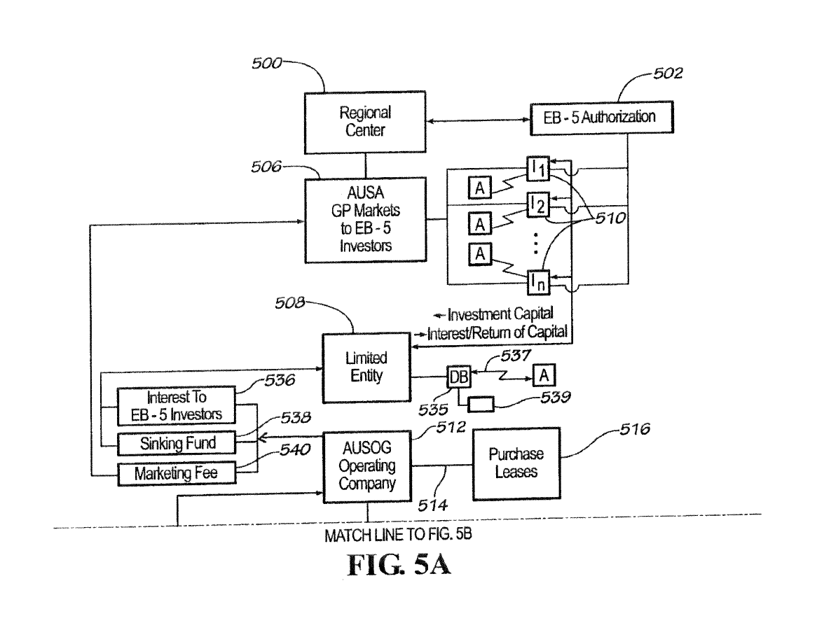

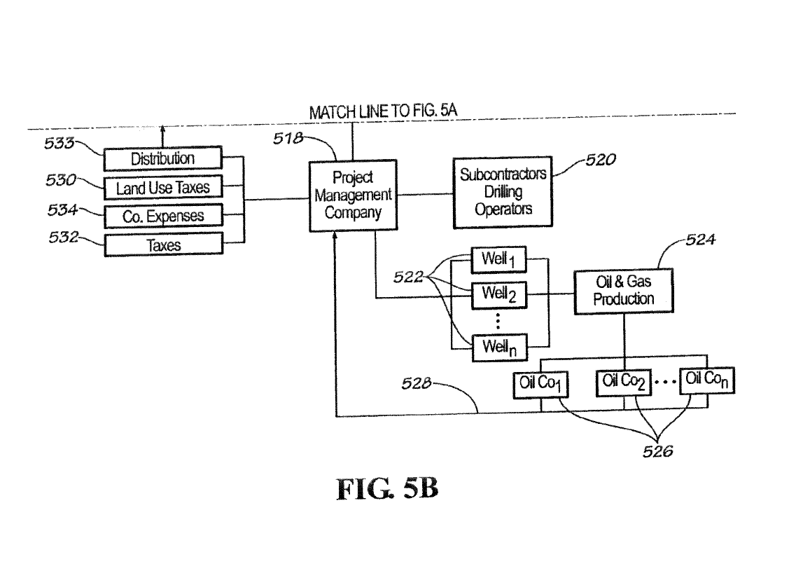

FIGS. 5A and 5B illustrate a schematic system overview and architecture 500 for an EB-5 immigrant investment system using a regional center 502. The regional center 502 is approved for EB-5 authorizations 504 for a plurality of immigrants/investors 510. The regional center 502 in the illustrated embodiment is directed to development of oil and gas projects in the United States through an Access U.S. Oil and Gas Entity (AUSA) 506. The AUSA 506 forms an entity, such as a limited partnership LP 508 by example and not limitation, together with the EB-5 investors 510. The AUSA 506 acts as general partner of the LP 508. The AUSA 506 provides marketing services on behalf of the regional center 502 to the EB-5 investors 510. The AUSA 506 works with interested investors/immigrants 510 to bring EB-5 investment to the LP 508. Each EB-5 investor 510 invests a required amount of EB-5 capital plus an additional amount in order to participate in the regional center 502. The EB-5 capital is provided to the limited partnership 508 and an administration fee is provided to AUSA 506 for services.

The AUSA 506 invests the capital with an Access U.S. Oil and Gas project entity (AUSOG) 512. The AUSOG 512 is a commercial enterprise directed to promotion of economic growth, improved regional productivity, job creation and increased capital investment, and particularly increased U.S. domestic capital investment. In the illustrated embodiment, the AUSOG 512 obtains the capital such as by a loan or investment from the AUSA 506. The AUSOG 512 engages in oil and gas exploration and recovery. The AUSOG 512 investigates and evaluates proposed oil gas exploration leases and opportunities available from a plurality of lease holders. The AUSOG 512 purchases 514 oil and gas leases 516.

AUSOG 512 may purchase and/or establish a project management company 518 to manage one or more oil and gas exploration and recovery projects accessible through the leases 516. Alternatively, AUSOG 512 may perform the functions of the project management company 518 discussed below. The project management company 518 works with subcontractors 520 including independent oil drilling operators contracted to drill and establish production wells 522. The wells 522 when operating produce barrels of oil and production of gas, generally production 524. The production 524 is sold to one or more oil processing companies 526 for refining into oil and gas products conventionally. The project management company 518 receives revenues 528 from sales of oil and gas production 524 to the oil companies 526. The project management company 518 works with the subcontractors 520, monitors production data, pays relevant tax and expenditures for its operations, and tracks the wells and the royalty payments. The AUSOG 512 however manages the development and well drilling on property subject of oil and gas leases 516 in order to facilitate development of drilling units in a timely manner to maximize earnings. The project management company 518 coordinates the sale of the oil and gas production 524 to oil companies 526 for refining purposes. Revenues 528 from the sale of such production 24 is received by the project management company 518. The revenue received by the project management company 518 is applied to land use royalty 530, taxes 532, and company general expenses and overhead 534. After expenses, revenue is distributed 533 by the project management company 518 to its investors such as ASOG 512.

In the illustrated embodiment, the LP 508 maintains and operates an electronic computer complex with an electronic database 535 accessible through a communications network 537 to the EB-5 investors as well as to the AUSA 506. The electronic database 535 maintains regional center 502 and EB-5 investor information, as well as accounting, management, contractual, and project information which includes but is not limited to project leases, subcontractor information, project status, and project financial information such as production, costs, and sales revenues. The access by particular persons to information may be selected and specified by AUSA 506.

In addition, AUSOG 512 makes an annual capital interest payment 536 for the investors 510. The payment may be made through the AUSA 506 on behalf of the LP 508. Other associated costs of the regional center 502 include a sinking fund 538 in which funds accrue. The accrued sinking fund 538 is used to repay investors 510 their EB-5 capital contribution within a pre-determined period of time. In the illustrated embodiment, the system contemplates that the sinking fund will accrue funds of approximately 20% to 25% of each EB-5 investor 510 capital contribution so that within five years all or substantially all of the capital necessary to repay each EB-5 investor his capital contribution has been accrued. A marketing fee 540 may be paid on behalf of the LP 508 to AUSA 506. In the illustrated embodiment, the electronic computer complex 535 further is configured 539 for analyzing revenues from project product production and sales, for determining the sinking fund accrual to the escrow account 538, and providing for return of the capital investments to the EB-5 investors after a pre-determined period of time with the accrued funds of the escrow account 538.

After expiration of the pre-determined investment period, AUSOG 512 used the accrued sinking fund 538 and repays the principal of the capital contributions made by the EB-5 investors 510. The remaining company assets held by the limited partnership LP 508 including all of the oil and gas wells 522, the leases 516, and other assets, are distributed to AUSA 506.

In an alternate embodiment, the sinking fund 538 is an independent escrow account on behalf of the project management company 518, AUSA 506, and the investors 510. The project management company 518 distributes to the escrow account 538 the appropriate sums for investor interest payments during the term, accrual funds for repayment of the investments by the investors 510 after the pre-determined investment period, and servicing funds payable to AUSA 506. The sinking fund 538 is operated by an agreement that provides for receipt and distribution of the funds independently. For example, the funds transferred annually by the project management company 518 and received by the sinking fund 538 may be distributed by agreement; for example, 20% paid to AUSA 506 as its servicing fee; 20% paid to investors as current year interest payment, and remaining 60% accrued for investor repayment at the end of the period.

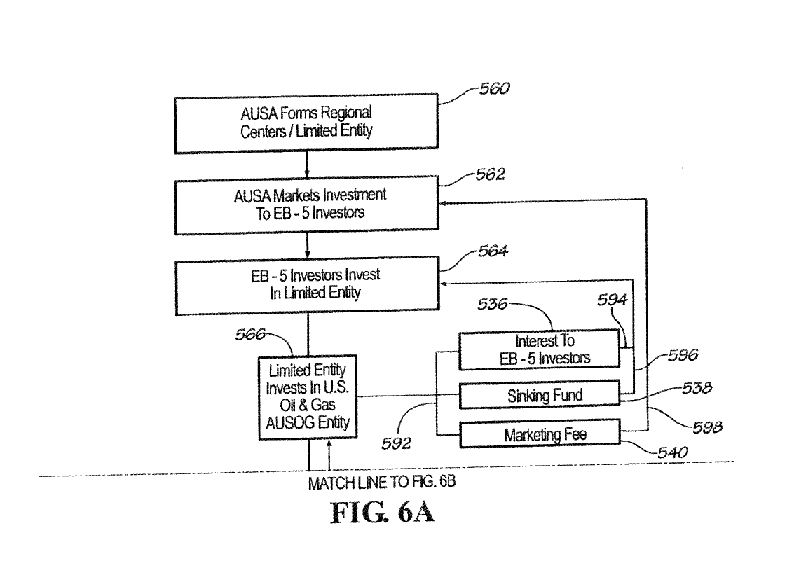

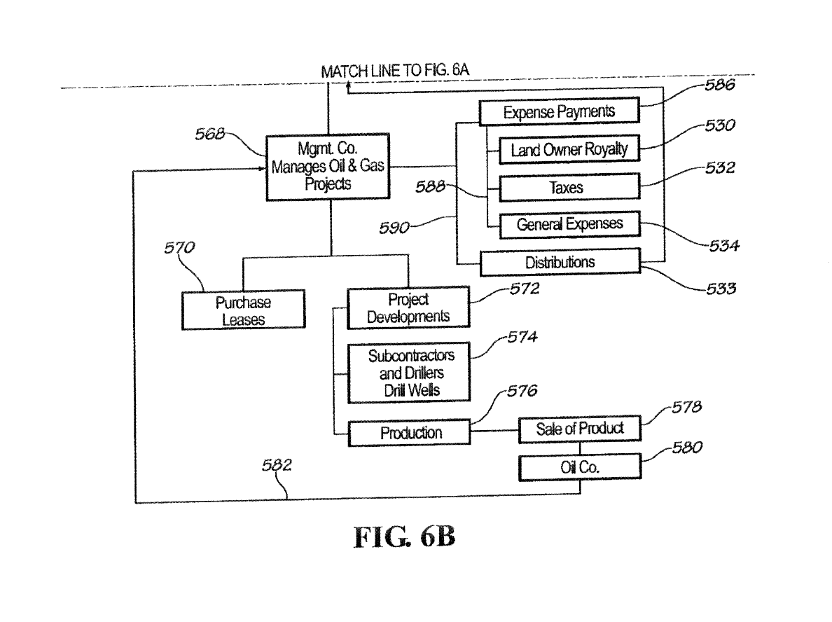

FIGS. 6A and 6B illustrate a flow chart of the EB-5 investment system according to the present invention. As participants in the regional center 502, the special energy entity AUSA 506 forms 560 the limited partnership entity 508 for participation by the plurality of EB-5 investors 510. It is to be appreciated that another form of entity such as a limited liability company may be established or used rather than a limited partnership for the LP 508 as used in this illustrative embodiment. The formed LP relies on AUSA 506 as manager or general partner for day-to-day operations. The AUSA 506 markets 562 the EB-5 investment program as the regional center 502 to the EB-5 investors 510. The EB-5 investors 510 invest 564 in the LP 508. This is accomplished by the payment of minimum investment amount required under the EB-5 program and the administrative fee for participation payable to the AUSA 506. It is to be appreciated that a broker dealer may gainfully be used for transfer of the investments by the investors 510 to the LP 508.

The LP 508 forms the AUSOG 512 entity for accessing U.S. oil and gas production opportunities 566. The AUSOG 512 forms or acquires 568 the project management company 518 to manage the oil exploration projects on behalf of AUSOG 512. The AUSOG 512 or the project management company 518 may investigate and purchase or direct purchase of land or leases for oil exploration and recovery 570. The AUSOG 512 thereby researches suitable commercialization projects that comply with investment guidelines under the EB-5 program. The project management company 518 prepares documents necessary for the project including leases and subcontracts for development of the leases, marketing the product production of the project, and accounting for the project. The AUSOG 512 establishes the escrow account 538 to hold funds until the pre-determined period of the regional center 502 has passed.

In that regard, the project management company 518 manages the production of oil and gas from loaned property and leased property 572. Management includes contracting 574 with independent drillers and other subcontractors for drilling and operating. Production is reported by the project management company 518 to the AUSOG 512. The project management company 518 sells 578 production from the wells to oil company and refiners 526. Revenue payments 528 transfer 582 to the project management company 518. The project management company 518 attends to expense payments. This includes transfers 588 for land owner royalties 530, taxes 532, and general company expenses and overhead 534. Periodically, the project management company 518 distributes 590 remaining revenues to its investors (such as AUSOG 512). The AUSOG 512 distributes 592 its receipts. The AUSOG 512 transfers the annual capital interest payment 536 to the LP 508 for payment 594 to the EB-5 investors 510. The AUSOG 512 transfers funds for the sinking fund 538 accrual account. After a pre-determined period of time the sinking fund 538 accrues sufficient funds to repay 596 the EB-5 investors 510 their initial EB-5 capital investment made in the LP 508. A marketing fee may also transfer 598 from the AUSOG 512 to AUSA 506 for compensation of its marketing services.

The electronic computer complex 535 is configured to receive, analyze and report on the regional center 502 in performance of promoting economic growth, improved economic regional productivity, job creation and increased capital investment by financing commercial economic activity that meets the requirements of the United States government EB-5 immigrant investor visa program. Particularly, and without limitation, the computer complex receives and displays project financing criteria information comprising one or more of infrastructure research information, economic modeling information, business and project document information, marketing information, and funds and investment transaction information. The LP 508 generate project and infrastructure research information, generates economic modeling information, generate business document information, generates project document information, generates marketing and pricing information, and performs transfers of moneys for the various purposes discussed above. The electronic computer complex 535 further is configured for communicating among the means for receiving and displaying project and financing criteria information, means for generating project and infrastructure research information, means for generating economic modeling information, means for generating business document information, means for generating project document information, means for generating marketing and pricing information, and means for performing fund transfers. This includes an analyzer configured for sorting and organizing information. Further, the complex is configured for receiving and displaying the project and infrastructure research information, economic modeling information, business document information, project document information, marketing and pricing information. In accordance with the present invention, the regional center 502 searches for, markets, and finances EB-5 capital investments economic projects (in the illustrated embodiment, oil and gas exploration and development) that meet the requirements of the United States government's EB-5 immigrant investor visa program.

The information displayed to the user or EB-5 investor 520 can be controlled through a configuration file associated with the electronic computer complex 535. Some organizations may not be concerned about some data fields, such as the Author and Company fields in the meta data. This information could be removed from the user's display, which would make it easier for the user to concentrate on more important objects. The configuration file could also allow some automatic processing to occur. For example, correctly marked images could be automatically cropped and resized, or object linking and embedding (OLE) objects could be automatically converted, all without user intervention.

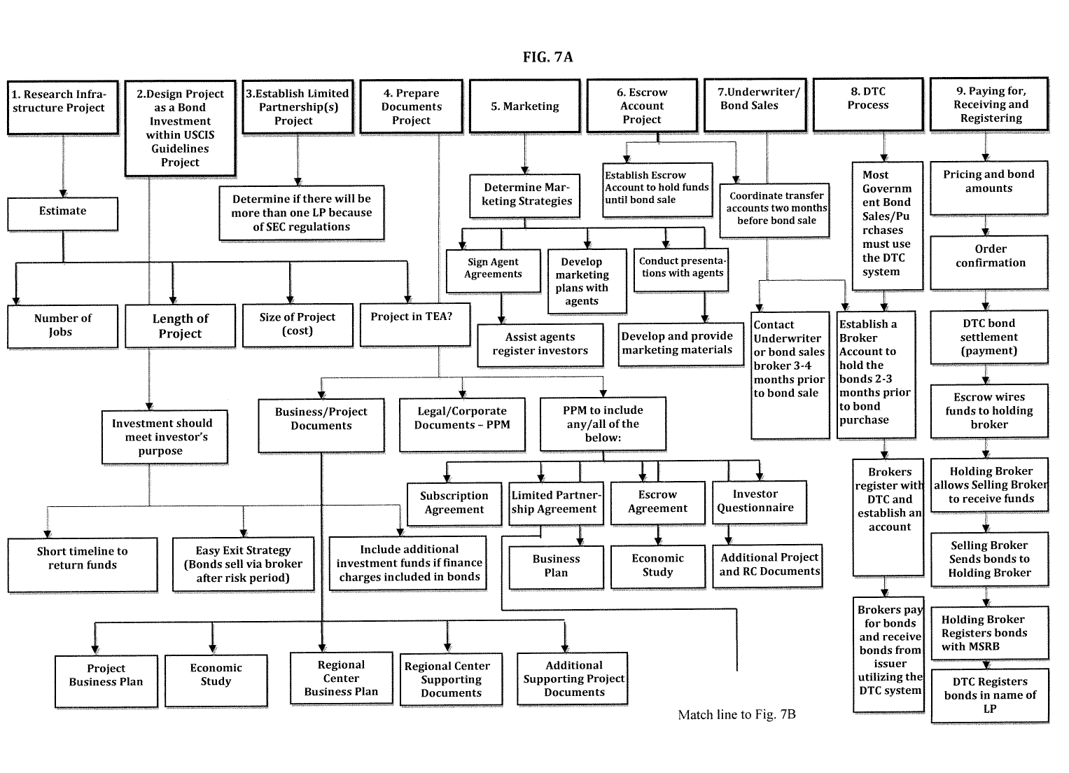

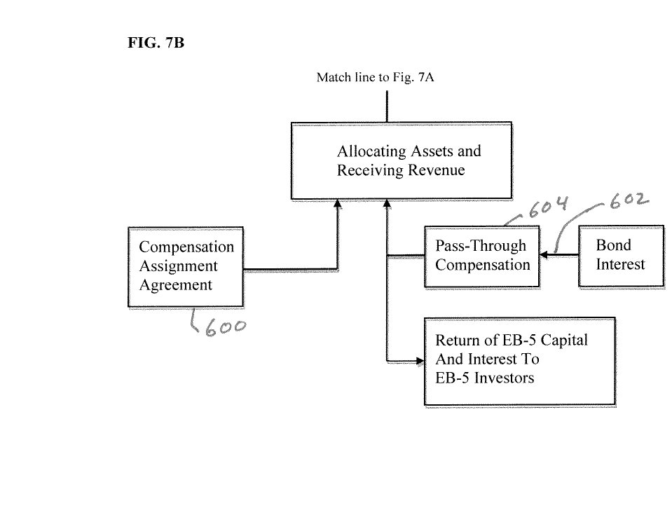

FIGS. 7A and 7B illustrate in schematic view a system overview and architecture of an alternate embodiment of the method for platinum government bond financing 40 using EB-5 immigrant investments for a regional center as described above in reference to FIG. 3. In this alternate embodiment of the computer-implemented commercial financial economic and investment development system establishing and operating economic development projects with investments that meet the requirements of the United States government EB-5 immigrant investor visa program disclosed herein, an agreement 600 provides for a compensation to a general manager managing the economic development project agreement by assignment of asset rights of each of the EB-5 investors to the general manager. Particularly, the asset rights comprise at least a percentage of an interest amount paid 602 by an issuer of the bonds acquired for the bond investment for the economic development project. In an alternate embodiment, the bonds comprise municipal bonds. The interest paid 602 through the assignment of asset rights provides general partner compensation. The compensation paid 604 for the management of the economic development project is derived from the assigned asset rights of the EB-5 investors as a direct pass-through in allocating assets and receiving the revenues associated with the bond investment and the project. At time of receipt of the interest payment by the partnership, the limited partners have already assigned the asset rights to the general partner.

By way of example and without limitation, distributions may provide that “Ninety-five percent (95%) of all cash attributable to interest from the Project Bonds shall be distributed to the General Partner promptly upon receipt by the Company. More particularly, in lieu of an annual management fee paid to the General Partner, the limited partners rather assign 600 a percentage of the interest in and to the assets to the General Partnership or limited liability company. In the case of bonds, the limited partners may assign a percentage of the annual bond interest 602 to the General Partner. The General Partner thus collects as assignee its share of the paid interest on the bonds.

The following is an illustrative example of assigning interest paid assets within a Limited Partnership to a General Partner:
Distributions: Ninety-five percent (95%) of all cash attributable to interest from the Project Bonds shall be distributed to the General Partner promptly upon receipt by the Company. After such distributions are made, the General Partner determines in its sole discretion the amount, if any, timing, and form of any distributions of Profits by the Company. Available Cash Flow, Net Proceeds from a Capital Event and/or distributions in liquidation of the Company (each as defined in the Limited Partnership Agreement), if any, shall be distributed at least annually to Partners in accordance with their respective Percentage Interests, with the Net Proceeds from a Capital Event being distributed first to Limited Partners to the extent of their initial Capital Contribution.
Allocation of Profits and Losses. Following allocation to the General Partner of ninety five percent (95%) of the interest income attributable to the Project Bonds, profits and losses for each fiscal year shall be allocated in the following order of priority: (a) first, to the Partners in accordance with their Capital Contributions, payable in proportion to the unpaid amounts thereof; and (2) the balance, to the Partners in accordance with their respective Percentage Interests. One Hundred Percent (100%) of the Company's “ordinary course expenses” shall be allocated to the General Partner until the amount for any Fiscal Year equals the sum of the interest income allocated from the Project Bonds for such Fiscal Year.

The percentages expressed are exemplary and may differ depending on circumstances of the investment matter. Other asset rights may be assigned.

In due course, the exit strategy of the present invention provides for return of EB-5 investor capital and interest (to the extent same is aggregated but not disbursed; for example, the residual portion not assigned to the general partner as compensation in the embodiment discussed above).

Examples of the present invention have been presented for use within the field of immigrant visa investor financing. However, it should be understood that the methods described could also be applied to other fields of finance.

While the invention has been described with respect to various illustrative embodiments, those skilled in the art, having benefit of this disclosure, will appreciate that other embodiments can be devised which do not depart from the scope of the invention as disclosed here. Accordingly, the scope of the invention should be limited only by the attached claims.

What is claimed is:

1. A computer-implemented commercial financial economic and investment development system establishing and operating economic development projects with investments that meet the requirements of the United States government EB-5 immigrant investor visa program, comprising:
a microprocessor center configured for the promotion of economic growth, improved economic productivity in a region, job creation and increased capital investment—through at least one economic development project financed by a project capital investment within U.S. Customs and Immigration Services guidelines for EB-5 immigrant investor visa program;
a plurality of EB-5 capital investments each purchasing a portion of the project capital investment issued by an entity established for economic commercialization of the economic development project funded by the project capital investment, the project capital investment comprising a bond investment having a plurality of bonds, each EB-5 capital investment received from a respective one of a plurality of EB-5 investors that participate in the economic development project;
a computer database operatively connected to the microprocessor center accessible through a communications network connecting at least one workstation to receive, maintain, and display economic development project and EB-5 investor information, including financing criteria information comprising one or more of infrastructure research information, economic modeling information, business and project document information, marketing information, and funds and investment transaction information;
a compensation agreement for assignment of asset rights of each of the EB-5 investors to a general manager managing the economic development project;
an escrow account to hold EB-5 capital investments of the EB-5 investors until sale of the bonds from the project capital investment;
a securities depository having a plurality of broker accounts through which a broker/dealer associated with a respective one of the broker accounts pays for the bonds using the escrow account and receives the paid-for bonds, the securities depository organized as a banking organization, a clearing corporation, and a securities clearing agency; and
a plurality of accounts provided by the broker/dealer, each account to hold a pro-rata value representative of the sold bonds in association with a respective one of the plurality of EB-5 investors based on the EB-5 capital investment thereof;
whereby each one of the plurality of EB-5 investors, being invested in the economic development project funded by the project capital investment, receive an EB-5 immigrant visa.

2. The computer-implemented commercial financial economic and investment development system as recited in claim 1, wherein the asset rights comprise at least a percentage of an interest amount paid by an issuer of the bonds acquired for the bond investment for the economic development project.

3. The computer-implemented commercial financial economic and investment development system as recited in claim 1, wherein the bonds comprise municipal bonds.

4. The computer-implemented commercial financial economic and investment development system as recited in claim 1, further comprising an ownership transfer or that receives instructions from a respective one of the plurality of EB-5 investors to transfer the bond associated with said EB-5 investor to a subsequent beneficial owner.

5. The computer-implemented commercial financial economic and investment development system as recited in claim 1, wherein the broker/dealer provides a depositor trust account for purchasing, receiving and registering bonds for each one of the plurality of the EB-5 investors.

6. The computer-implemented commercial financial economic and investment development system as recited in claim 1, wherein the economic development project further comprises a marketer that markets the investment and the economic development project to a plurality of potential EB-5 investors.

7. The computer-implemented commercial financial economic and investment development system as recited in claim 1, further comprising an operating entity that uses the EB-5 capital investments of the EB-5 investors to engage in the economic development project.

8. The computer-implemented commercial financial economic and investment development system as recited in claim 7, wherein the operating entity registers with appropriate government agencies for marketing of the investment for the economic development project to a plurality of potential EB-5 investors.

9. The computer-implemented commercial financial economic and investment development system as recited in claim 1, further comprises a document originator associated with the regional center for preparing legal and entity documents related to the regional center, the entity, and the economic development project.

10. The computer-implemented commercial financial economic and investment development system as recited in claim 9, wherein said legal and entity documents comprise EB-5 investor subscription agreement, entity organizing and operating agreements, investment escrow agreements and EB-5 investor questionnaire.

11. The computer-implemented commercial financial economic and investment development system as recited in claim 1, further comprises a document originator associated with the regional center for preparing business/project documents related to the regional center, the entity, and the economic development project.

12. The computer-implemented commercial financial economic and investment development system as recited in claim 11, wherein said business/project documents comprise a project business plan, an economic study, and a regional center business plan.

13. The computer-implemented commercial financial economic and investment development system as recited in claim 1, wherein the broker account is a Depository Trust Company account.

14. The computer-implemented commercial financial economic and investment development system as recited in claim 1, wherein the broker/dealer is a direct participant, the broker account is a direct participant account, and further comprising an electronic computerized book-entry device maintained by the securities depository of transfers and pledges of the broker account.

15. The computer-implemented commercial financial economic and investment development system as recited in claim 14, further comprising a plurality of indirect participants that each maintains a custodial relationship with the direct participant.

16. The computer-implemented commercial financial economic and investment development system as recited in claim 14, further comprising an owner record file maintained by the securities depository recording an identity of the direct participant in association with the bonds credited in the broker account; and a direct broker record file maintained by the direct participant having a corresponding record identifying one of a plurality of customers associated with a respective bond.

17. The computer-implemented commercial financial economic and investment development system as recited in claim 16, wherein the security depository is configured to determine by lot an amount of the interest of each direct participant in a bond issue to redeem if less than all of the bonds in a Series are to be redeemed.

18. The computer-implemented commercial financial economic and investment development system as recited in claim 16, further comprising an information display device controlled through a configuration file for display of information from the computer database accessed through a network.
